(19) United States
(12) Patent Application Publication
(10) Pub. No.: US 2018/0375661 A1
(43) Pub. Date: Dec. 27, 2018

(54) DEVICE

(71) Applicant: ZWIPE AS, Oslo (NO)

(72) Inventors: Jose Ignacio Wintergerst LAVIN, Colorado Springs, CO (US); Peter Robert LOWE, Peyton, CO (US)

(21) Appl. No.: 16/062,210

(22) PCT Filed: Dec. 15, 2016
(86) PCT No.: PCT/EP2016/081256

§ 371 Date: Jun. 14, 2018

Related U.S. Application Data
(60) Provisional application No. 62/268,512, filed on Dec. 17, 2015.

(30) Foreign Application Priority Data
Feb. 23, 2016 (GB) 1603099.1

(51) Int. Cl. H04L 9/32; G06K 19/07; G06F 21/32; G06K 19/073; H04L 29/06; G06F 21/35

(52) U.S. Cl. CPC H04L 9/3231; G06K 19/0718; G06F 21/32; H04L 2209/805; H04L 9/3228; H04L 63/0861; G06F 21/35; G06K 19/07354

(57) ABSTRACT

A passive, one-time password device may include a fingerprint authentication engine and a wireless communication module. The device may be passive, and therefore powered only by energy harvested from a radio-frequency (RF) excitation field. The device also may be configured to use the wireless communication module to wirelessly communicate a one-time password responsive to verifying the identity of a bearer of the device using the fingerprint authentication engine.

The present invention relates to a one-time password device, and particularly to a one-time password device incorporating an on-board fingerprint sensor.

A one-time password (OTP) is a password that is valid for only one login session or transaction on a computer system or other digital device. OTPs avoid a number of shortcomings that are associated with traditional (static) password based authentication.

The most significant advantage of using OTPs is that, in contrast to static passwords, they are not vulnerable to replay attacks. This means that a potential intruder who manages to record an OTP that has already been used to log into a service or to conduct a transaction will not be able to abuse it, since it will no longer be valid. A second major advantage is that a user who uses the same (or similar) password for multiple systems is not made vulnerable on all of them if the password for one of these is gained by an attacker.

One of the problems with OTPs is that the device for generating the OTP may become separated from its owner and criminals may attempt to steal such a device to use it to gain unauthorised access to the owner's accounts. A number of implementations for OTPs incorporate two factor authentication by ensuring that the one-time password requires access to a device a person physical possesses (such as a small fob device with the OTP calculator built into it, or a smartcard or specific mobile phone) as well as something only the authorised person knows (such as a PIN).

An effective way to associate a person with their device is by using biometric identification, and fingerprint verification is the easiest, cheapest and most practical for most purposes. Existing OTP devices incorporating fingerprint authentication include the plusID™ range of products, manufactured by Privaris®, and the HYPR Token™, manufactured by HYPR Corp. These devices both use a dedicated OTP token having an on-board fingerprint sensor, powered by a local battery housed within the device, which is used to verify the identity of the bearer based on their fingerprint. Responsive to successful verification, these devices then draw power from the battery to communicate wirelessly with a reader, using NFC and Bluetooth® respectively, to transmit the OTP.

The present invention provides, in a first aspect, a passive, one-time password device comprising a fingerprint authentication engine and a wireless communication module, the device being configured to use the wireless communication module to wirelessly communicate a one-time password responsive to verifying the identity of a bearer of the device using the fingerprint authentication engine, and the device being powered by energy harvested from a radio-frequency (RF) excitation field.

This device is completely passive, i.e. it does not include a battery and power for all on-board components is harvested from an RF field, for example by using an antenna associated with the wireless communication module. By powering the components wirelessly, the reliability of the device can be enhanced because it is not dependent upon a battery.

The fingerprint authentication engine preferably comprises a fingerprint sensor, a processing unit and a memory. The fingerprint authentication engine may be configured to compare a fingerprint of a finger presented to the fingerprint sensor to reference fingerprint data stored in the memory, i.e. to perform a fingerprint matching process, to authorise the bearer of the device. The fingerprint authentication engine may also be configured to perform a fingerprint enrolment process, i.e. to store a fingerprint data received from the fingerprint sensor in the memory as reference fingerprint data.

The fingerprint authentication engine may be configured to authorise the wireless communication module to wirelessly communicate the one-time password responsive to verifying the identity of a bearer of the device. For example, the fingerprint authentication engine may communicate a digital authorisation command to the wireless communication module. Alternatively, the fingerprint authentication engine may cause power to be supplied to the wireless communication module, or part thereof.

The wireless communication module preferably comprises a one-time password generator. The fingerprint authentication engine may be configured to authorise the one-time password generator to generate a one-time password responsive to verification of the bearer. For example, the one-time password generator may generate a unique, one-time password each time it is powered or when it receives an appropriate command, e.g. the command from the fingerprint authentication engine.

The wireless communication module is preferably a radio-frequency (RF) communication module, and more particularly an NFC (near field communication) module. RF and NFC modules are particularly well suited to passive devices as they can utilise backscatter modulation to transmit the return signal.

The device may further comprise a display portion for visually displaying a one-time password, which may or may not be the same as the one-time password communicated wirelessly to the reader.

The OTP device may be arranged to perform a method, comprising: receiving a command from a powered RFID reader; receiving a substantially continuous radio-frequency excitation field whilst the RFID reader waits for a response to the command; performing a fingerprint processing process; determining a period that the RFID reader has been waiting for a response; and responsive to determining that the period exceeds a predetermined threshold, if the process has not been completed, sending a request for a wait time extension to the RFID reader.

A typical RFID reader will pulse its excitation signal on and off so as to conserve energy, rather than steadily emitting the excitation signal. Often this pulsing results in a duty cycle of useful energy of less than 10% of the power emitted by steady emission. This may be insufficient to power a fingerprint authentication engine, and particularly where the fingerprint authentication engine includes an area-type fingerprint scanner, which has relatively high power consumption. Indeed, in a preferred embodiment, a fingerprint sensor of the fingerprint authentication engine is an area-type fingerprint sensor.

The above method performed by the OTP device overcomes this problem by taking advantage of certain aspects of the standard functionality of a RFID reader complying with, for example, international standard ISO/IEC 14443. Particularly, whilst the RFID reader waits for a response to a command, it must maintain a non-pulsing, preferably a substantially continuous, RF excitation field.

Thus, in accordance with this method, when the RFID reader sends a command to the OTP device, the device does not respond, but rather waits and harvests the power to drive the functionality of the fingerprint authentication engine.

The fingerprint processing process is preferably one not directly required for responding to the command, for example the command may be a “request to provide identification code” command and the process may be a fingerprint matching or enrolment process. That is to say, a response to the command from the RFID reader is intentionally delayed so as to allow the fingerprint processing to be performed.

In the preferred embodiments, the OTP device does not respond to the command whilst the process is being performed. Furthermore, the method preferably further comprises: only after the process has been completed, responding by the OTP device to the command.

The steps of “determining a period that the RFID reader has been waiting for a response; and responsive to determining that the period exceeds a predetermined threshold, if the process has not been completed, sending by the OTP device a request for a wait time extension to the RFID reader” are preferably repeated until the process is completed and/or a response to the command has been sent. For example, after the process has been completed, the OTP device may allow the wait time to expire, if no further communication with the RFID reader is required. Alternatively, a response to the RFID reader may be sent, for example if the process was part of an authorisation step before responding to the command.

Preferably, the period is a time since the command was received or since the last wait time extension request was made. Thus, the request for a wait time extension can be sent before expiry of the current wait time to ensure that the RFID reader continues to maintain the RF excitation field until the process is complete.

Without using a request for a wait time extension, the maximum default time that a non-pulsing RF excitation field could be supplied is 4.949 seconds for an RFID reader complying with international standard ISO/IEC 14443 (and in practice, the default maximum wait time of the RFID device will be much lower than this). Thus, the method performed by the OTP device is particularly applicable to fingerprint matching and enrolment, as these processes require input from the user (e.g. one or more fingerprint scans), which can only be processed at the rate that they are supplied by the user of the device. The method particularly allows these processes to be performed by the fingerprint authentication engine when the process requires greater than 5.0 seconds to be completed.

As discussed above, the method is particularly applicable to OTP devices and RFID readers complying with international standard ISO/IEC 14443 (although the OTP device may be applicable also to other standards operating in a similar manner), and thus the device is preferably a proximity integrated circuit card (PICC) and the RFID reader is preferably a proximity coupling device (PCD). The PICC and PCD preferably comply with the definitions set forth in the international standard ISO/IEC 14443. The predetermined threshold is preferably below a pre-arranged first wait time of the PICC and the PCD.

The OTP device may be any one of: an access token, an identity token, a cryptographic token, or the like. Such tokens may be manufactured in the form of a card, a fob, or any other suitable form. The device may also be any type of payment card, such as a credit card, a debit card, a pre-pay card, or the like.

The present invention also provides, in a second aspect, a method comprising: providing a one-time password device including a fingerprint authentication engine and a wireless communication module; verifying the identity of the bearer of the one-time password device using the fingerprint authentication engine; and responsive to verifying the identity of the bearer, transmitting a one-time password using the wireless communication module, wherein the fingerprint authentication engine and the wireless communication module are powered by energy harvested from a radio-frequency (RF) excitation field.

As above, powering the components passively by harvested power increases the reliability of the device by removing its dependence upon a battery. In various embodiments, the one-time password device is a device according to the first aspect, optionally including any or all of the optional features thereof.

The verifying of the identity of the bearer may comprise the steps of scanning a fingerprint of a finger presented to a fingerprint sensor of the fingerprint authentication module, and comparing the scanned fingerprint with stored reference fingerprint data. The identity of the bearer may be verified when the scanned fingerprint and the stored reference fingerprint data match to within a predetermined degree of confidence.

The method may comprise responsive to verifying the identity of the bearer, providing power to the wireless communication module, or a portion thereof, to authorise transmission of the one-time password. Alternatively, the method may comprise responsive to verifying the identity of the bearer, sending an authorisation command to the wireless communication module to authorise transmission of the one-time password.

The method may comprise, responsive to authorisation to transit the one-time password, generating a unique, one-time password, and transmitting a one-time password using the wireless communication module.

The method may further comprise visually displaying a one-time password to the bearer. The displayed password may or may not be the same as the one-time password transmitted by the wireless communication module.

In some embodiments, the wireless communication module is an NFC (near field communication) module, and the RF excitation is an NFC excitation field.

A fingerprint sensor of the fingerprint authentication engine may be an area-type fingerprint sensor.

The method may further comprise: receiving a command from a powered RFID reader; receiving a substantially continuous radio-frequency excitation field whilst the RFID reader waits for a response to the command; performing a fingerprint processing process; determining a period that the RFID reader has been waiting for a response; and responsive to determining that the period exceeds a predetermined threshold if the process has not been completed, sending a request for a wait time extension to the RFID reader. Thus, when the RFID reader sends a command to the OTP device, the OTP device does not respond, but rather waits and harvests the power to drive the functionality of the fingerprint authentication engine.

The fingerprint processing process is preferably one not directly required for responding to the command, for example the command may be a “request to provide identification code” command That is to say, a response to the command from the RFID reader is intentionally delayed so as to allow the processing to be performed.

In the preferred embodiments, the OTP device does not respond to the command whilst the process is being performed. Furthermore, the method preferably further comprises: after the process has been completed, responding by the OTP device to the command.

The steps of “determining a period that the RFID reader has been waiting for a response; and responsive to determining that the period exceeds a predetermined threshold, if the process has not been completed, sending by the OTP device a request for a wait time extension to the RFID reader” are preferably repeated until the process is completed and/or a response to the command has been sent. For example, after the process has been completed, the OTP device may allow the wait time to expire, if no further communication with the RFID reader is required. Alternatively, a response to the RFID reader may be sent, for example if the process was part of an authorisation step before responding to the command.

Preferably, the period is a time since the command was received or since the last wait time extension request was made. Thus, the request for a wait time extension can be sent before expiry of the current wait time to ensure that the RFID reader continues to maintain the RF excitation field until the process is complete.

The method performed by the OTP device controller may be a fingerprint matching or enrolment process.

The OTP device is preferably a proximity integrated circuit card (PICC) and the RFID reader is preferably a proximity coupling device (PCD). The PICC and PCD preferably comply with the definitions set forth in the international standard ISO/IEC 14443. The predetermined threshold is preferably below a pre-arranged first wait time of the PICC and the PCD.

The device may be any one of: an access token, an identity token, a cryptographic token, a loyalty card, a payment card (such as a credit card, a debit card or a pre-pay card), or the like.

Certain preferred embodiments of the present invention will now be described in greater detail, by way of example only and with reference to the accompanying Figures, in which:

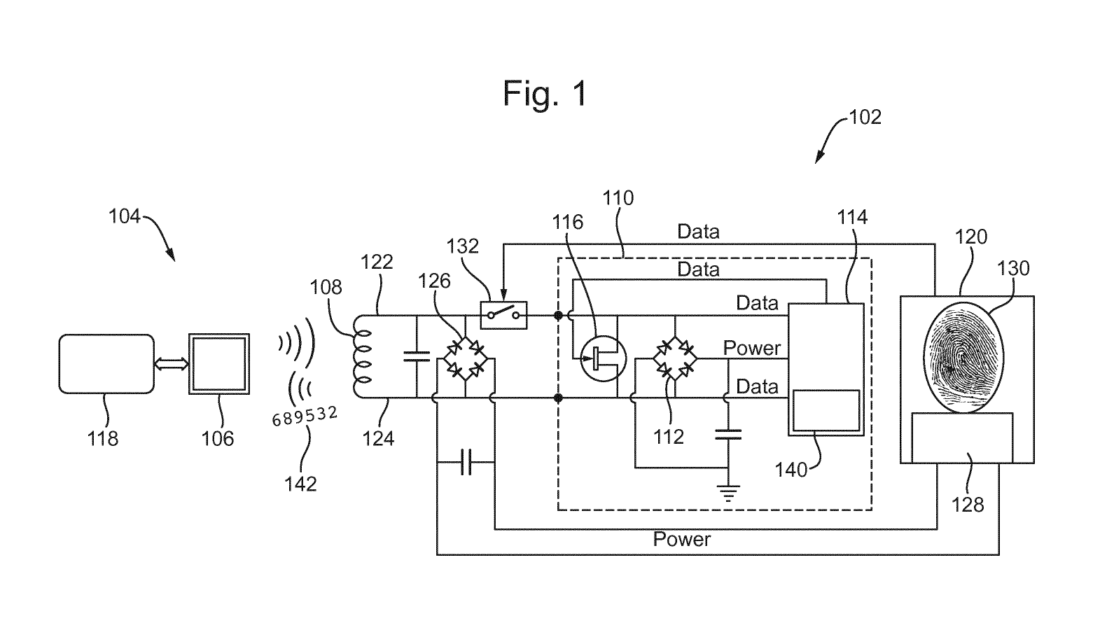

FIG. 1 illustrates a circuit for a passive, one-time password device incorporating a fingerprint scanner; and

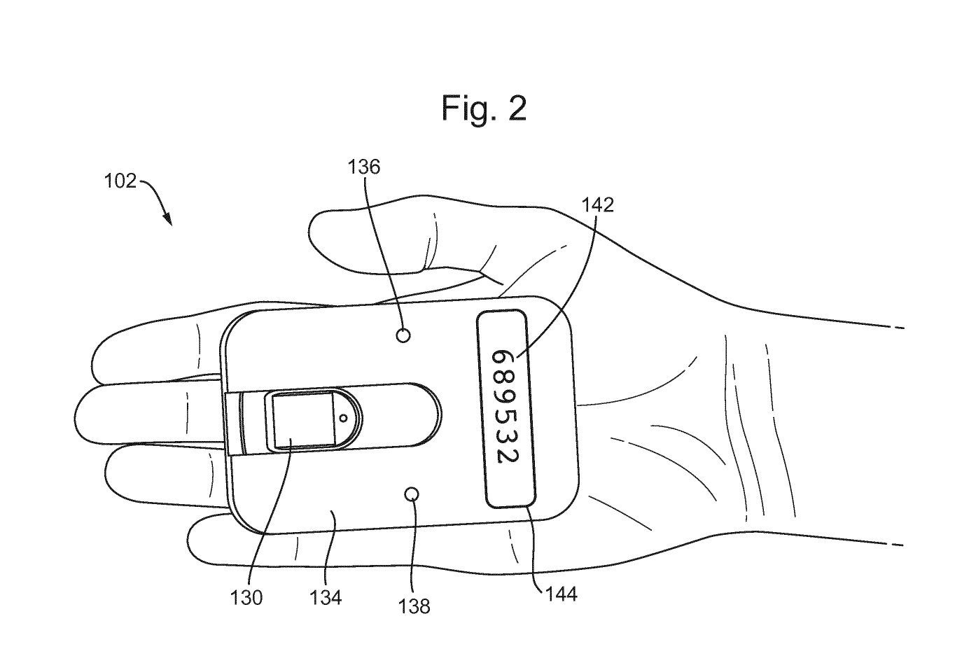

FIG. 2 illustrates an external housing of the device.

FIG. 1 shows the architecture of a passive, one-time password (OTP) device 102 and a powered RFID reader 104, which may be an NFC reader.

The powered reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp.

This signal is received by an antenna 108 of the OTP device 102, which comprises a tuned circuit, in this arrangement including a coil and a capacitor, tuned to receive an RF signal from the reader 104. When exposed to the excitation field generated by the reader 104, a voltage is induced across the antenna 108.

The antenna 108 has first and second end output lines 122, 124, one at each end of the antenna 108. The output lines of the antenna 108 are connected to a fingerprint authentication engine 120 to provide power to the fingerprint authentication engine 120. A rectifier 126 is provided to rectify the AC voltage received by the antenna 108. The rectified DC voltage is smoothed using a smoothing capacitor and supplied to the fingerprint authentication engine 120.

The fingerprint authentication engine 120 includes a processing unit 128 and a fingerprint reader 130, which is preferably an area fingerprint reader 130 as shown in FIG. 2. The fingerprint authentication engine 120 is powered (only) by the voltage output from the antenna 108. The processing unit 128 comprises a microprocessor that is chosen to be of very low power and very high speed, so as to be able to perform biometric matching in a reasonable time.

The fingerprint authentication engine 120 is arranged to scan a finger or thumb presented to the fingerprint reader 130 and to compare the scanned fingerprint of the finger or thumb to stored reference fingerprint data using the processing unit 128. A determination is then made as to whether the scanned fingerprint matches the reference fingerprint data. Ideally, the time required for capturing a fingerprint image and accurately recognising an enrolled finger is less than one second.

If a match is determined, then an OTP chip 110 is authorised to transmit a signal to the reader 104. In this embodiment, this is done by closing a switch 132 between the antenna 108 and the OTP chip 110 to provide power to the OTP chip 110. However, in other embodiments, this may be performed digitally by sending an electronic signal from the fingerprint authentication engine 120 to a controller 114 of the chip 110.

The OTP chip 110 comprises terminals connected to the first and second output lines 122, 124 from the antenna 108, in parallel with the fingerprint authentication engine 120 (and in series with the switch 132). The voltage received from the antenna 108 is rectified by a bridge rectifier 112 on the chip 110, and the DC output of the rectifier 112 is provided to a controller 114 of the chip 110.

The controller 114 comprises one-time password generation logic 140, which generates a one-time password 142 when powered. In order to transmit the one-time password 142 to the reader 104, data is output from the controller 114 passed to a field effect transistor 116 that is connected across the antenna 108. By switching on and off the transistor 116, a signal can be transmitted by the device 102 and decoded by suitable control circuits 118 in the reader 104. This type of signalling is known as backscatter modulation and is characterised by the fact that the reader 104 is used to power the return message to itself.

In the present arrangement, the power for both the OTP chip 110 and the fingerprint authentication engine 120 is harvested from the excitation field generated by the reader 104. That is to say, the OTP device 102 is a (completely) passive device, and has no battery.

The rectified output from second bridge rectifier 126 is used to power the fingerprint authentication engine 120 However, the power required for this is relatively high compared to the power demand for the components of a normal RFID device, or the like, that might be used with the reader 104. For this reason, is has not previously been possible to incorporate a fingerprint reader 130 into a passive OTP device 102. Special design considerations are used in the present arrangement to power the OTP chip 110 and fingerprint reader 130 using power harvested from the excitation field of the reader 104.

One problem that arises when seeking to power the chip 110 and fingerprint authentication engine 120 is that typical RFID/NFC readers 104 pulse their excitation signal on and off so as to conserve energy, rather than steadily emitting the excitation signal. Often this pulsing results in a duty cycle of useful energy of less than 10% of the power emitted by steady emission. This is insufficient to power the fingerprint authentication engine 120.

Many readers 104 conform to ISO/IEC 14443, the international standard that defines proximity cards used for identification, and the transmission protocols for communicating with them. When communicating with such readers 104, the OTP device 102 can take advantage of a certain feature of these protocols, which will be described below, to switch the excitation signal from the reader 104 to continuous for long enough to perform the necessary calculations.

The ISO/IEC 14443-4 standard defines the transmission protocol for proximity cards. ISO/IEC 14443-4 dictates an initial exchange of information between a proximity integrated circuit card (PICC), i.e. the device 102, and a proximity coupling device (PCD), i.e. the reader 104, that is used, in part, to negotiate a frame wait time (FWT). The FWT defines the maximum time for PICC to start its response after the end of a PCD transmission frame. The PICC can be set at the factory to request an FWT ranging from 302 ps to 4.949 seconds.

ISO/IEC14443-4 dictates that, when the PCD sends a command to the PICC, such as a request for the PICC to provide an identification code, the PCD must maintain an RF field and wait for at least one FWT time period for a response from the PICC before it decides a response timeout has occurred. If the PICC needs more time than FWT to process the command received from the PCD, then the PICC can send a request for a wait time extension (S(WTX)) to the PCD, which results in the FWT timer being reset back to its full negotiated value. The PCD is then required to wait another full FWT time period before declaring a timeout condition.

If a further wait time extension (S(WTX)) is sent to the PCD before expiry of the reset FWT, then the FWT timer is again reset back to its full negotiated value and the PCD is required to wait another full FWT time period before declaring a timeout condition.

This method of sending requests for a wait time extension can be used to keep the RF field on for an indefinite period of time. While this state is maintained, communication progress between the PCD and the PICC is halted and the RF field can be used to harvest power to drive other processes that are not typically associated with smart card communication, such as fingerprint enrolment or verification.

Thus, with some carefully designed messaging between the device 102 and the reader 104, enough power can be extracted from the reader 104 to enable the authentication cycle. This method of harvesting power overcomes one of the major problems of powering a passive fingerprint authentication engine 120 in a passive OTP device 102, particularly for when a fingerprint is to be enrolled onto the device 102 as is discussed later.

Furthermore, this power harvesting method allows a larger fingerprint scanner 130 to be used, and particularly an area fingerprint scanner 130, which outputs data that is computationally less intensive to process (and hence faster).

FIG. 2 shows an exemplary housing 134 of the device 102. The circuit shown in FIG. 1 is housed within the housing 134 such that a scanning area of the fingerprint reader 130 is exposed from the housing 134.

The housing further comprises a display interface 144 that displays a one-time password 142 to the user. The displayed one-time password 142 may be the same one-time password as is transmitted to the reader 104, or may be a different password 142 that is used either in combination with that transmitted wirelessly, or as an alternative one-time password 142, for example for devices that are not compatible with a wirelessly-transmitted one-time password 142.

Prior to use a new user of the device 102 must first enroll their fingerprint date onto a “virgin” device, i.e. not including any pre-stored biometric data. This may be done by presenting his finger to the fingerprint reader 130 one or more times, preferably at least three times and usually five to seven times. An exemplary method of enrolment for a fingerprint using a low-power swipe-type sensor is disclosed in WO 2014/068090 A1, which those skilled in the art will be able to adapt to the area fingerprint sensor 130 described herein.

The housing may include indicators for communication with the user of the device 102, such as the LEDs 136, 138 shown in FIG. 2. During enrolment, the user may be guided by the indicators 136, 138, which tell the user if the fingerprint has been enrolled correctly. The LEDs 136, 138 on the device 102 may communicate with the user by transmitting a sequence of flashes consistent with instructions that the user he has received with the device 102.

After several presentations, the fingerprint will have been enrolled and the device 102 may be forever responsive only to its original user.

With fingerprint biometrics, one common problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read. If a fingerprint is scanned with a number of different terminals, each one being slightly different, then errors can occur in the reading of the fingerprint. Conversely, if the same fingerprint sensor is used every time then the likelihood of such errors occurring is reduced.

As described above, the present device 102 includes a fingerprint authentication engine 120 having an on-board fingerprint sensor 130 as well as the capability of enrolling the user, and thus both the matching and enrolment scans may be performed using the same fingerprint sensor 130. As a result, scanning errors can be balanced out because, if a user tends to present their finger with a lateral bias during enrolment, then they are likely to do so also during matching.

Thus, the use of the same fingerprint sensor 130 for all scans used with the device 102 significantly reduces errors in the enrolment and matching, and hence produces more reproducible results.

Furthermore, security can be improved by using only a single device 102 for enrolment and matching, as the biometric data representing the fingerprint never needs to leave the device 102. This avoids the needs for a central database of biometric data, which could be targeted by criminals, and instead only the data required to verify the one-time passwords generated by the OTP logic 140 of the device 102 needs to be stored. If the security of this data is compromised, then new devices 102 can be issued, whereas a user's fingerprint cannot be readily changed.

We claim:

1. A passive, one-time password device comprising a fingerprint authentication engine and a wireless communication module, the device being configured to use the wireless communication module to wirelessly communicate a one-time password responsive to verifying the identity of a bearer of the device using the fingerprint authentication engine, and the device being powered by energy harvested from a radio-frequency (RF) excitation field, wherein the device is arranged to perform a method, comprising:
receiving a command from a powered RFID reader;
receiving a substantially continuous radio-frequency excitation field whilst the RFID reader waits for a response to the command;
performing a fingerprint processing process;
determining a period that the RFID reader has been waiting for a response; and
responsive to determining that the period exceeds a predetermined threshold, if the fingerprint processing process has not been completed, sending a request for a wait time extension to the RFID reader.

2. A device according to claim 1, wherein the fingerprint authentication engine comprises a fingerprint sensor, a processing unit and a memory, and wherein the processing unit is configured to verifying the identity of a bearer of the device by comparing a fingerprint of a finger presented to the fingerprint sensor with reference fingerprint data stored in the memory.

3. A device according to claim 2, wherein the device is configured to perform an enrolment process using the fingerprint to generate the reference fingerprint data.

4. A device according to claim 2, wherein the fingerprint sensor is an area-type fingerprint sensor.

5. A device according to claim 1, wherein the wireless communication module comprises a one-time password generator.

6. A device according to claim 1, wherein the wireless communication module is an NFC module.

7. A device according to claim 1, further comprising a display portion for visually displaying a one-time password.

8. A device according to claim 1, wherein the device is configured not respond to the command whilst the fingerprint authentication engine is performing the fingerprint processing process, and wherein the method further comprises, after the fingerprint authentication engine completes the fingerprint processing process, responding to the command.

9. A device according to claim 1, wherein the device is a proximity integrated circuit card (PICC) and the RFID reader is a proximity coupling device (PCD).

10. A device according to claim 9, wherein the predetermined threshold is below a pre-arranged first wait time (FWT) of the PICC and the PCD.

11. A device according to claim 1, wherein the device is one of: an access token, an identity token, a cryptographic token, a payment card, a credit card, a debit card and a pre-pay card.

12. A method comprising:
providing a one-time password device including a fingerprint authentication engine and a wireless communication module;
receiving a command from a powered RFID reader;
receiving a substantially continuous radio-frequency excitation field whilst the RFID reader waits for a response to the command;
performing a fingerprint processing process including verifying the identity of the bearer of the one-time password device using the fingerprint authentication engine;
determining a period that the RFID reader has been waiting for a response; and
responsive to determining that the period exceeds a predetermined threshold, if the fingerprint processing process has not been completed, sending a request for a wait time extension to the RFID reader;
responsive to verifying the identity of the bearer, transmitting a one-time password using the wireless communication module,
wherein the one-time password device is a passive, one-time password device such that the fingerprint authentication engine and the wireless communication module are powered by energy harvested from a radio-frequency (RF) excitation field.

13. A method according to claim 12, wherein verifying of the identity of the bearer comprises scanning a fingerprint of a finger presented to a fingerprint sensor of the fingerprint authentication module, and comparing the scanned fingerprint with stored reference fingerprint data.

14. A method according to claim 12, wherein the method comprises:
responsive to verifying the identity of the bearer, providing power to the wireless communication module, or a portion thereof, to authorise transmission of the one-time password.

15. A method according to claim 12, wherein one-time password is transmitted using NFC.

16. A method according to claim 12, wherein the RFID device does not respond to the command whilst the fingerprint authentication engine is performing the process, and where the method preferably further comprises, after the fingerprint authentication engine completes the process, responding by the RFID device to the command.

17. A method according to claim 12, wherein the RFID device is a proximity integrated circuit card (PICC) and the RFID reader is a proximity coupling device (PCD).

18. A method according to claim 17, wherein the predetermined threshold is below a pre-arranged first wait time (FWT) of the PICC and the PCD.
